(19) United States
(12) Patent Application Publication
(10) Pub. No.: US 2006/0138330 A1
(43) Pub. Date: Jun. 29, 2006

(54) Flexible liquid-filled ionizing radiation scintillator used as a product level detector

(75) Inventors: Charles E. Baldwin, Florence, KY (US); Craig A. Caris, Dry Ridge, KY (US)

Correspondence Address: Frederick H. Gribbell;FREDERICK H. GRIBBELL, LLC, Suite 120, 10250 Alliance Road, Cincinnati, OH, 45242, US

(73) Assignee: Ronan Engineering Company

(21) Appl. No.: 11/351,990

(22) Filed: Feb. 10, 2006

Related U.S. Application Data
(63) Continuation-in-part of application No. 10/810,144, filed on Mar. 26, 2004.
(60) Provisional application No. 60/458,694, filed on Mar. 28, 2003.

(51) Int. Cl. G01F 23/288

(52) U.S. Cl. 250/357.1

(57) ABSTRACT

A flexible scintillation-type level detector (10), in which the scintillator (18) is made from a flexible tube (12) substantially filled with a liquid scintillating material (16) to provide flexibility in at least two, and preferably three, dimensions. At least one end (32) is aligned for operable connection to a photodetector (14, 20). Outer surfaces of the flexible tube (12) may be covered with an inwardly-facing light reflective material (30) and/or light-excluding material or flexible armored casing (22). The scintillator (18) may include a variable-volume expansion chamber (110, 152, 176) to compensate for thermal expansion and contraction of the liquid scintillator material (16).

### CROSS-REFERENCE TO RELATED APPLICATIONS

The present application is a continuation-in-part to application Ser. No. 10/810,144, titled “FLEXIBLE LIQUID-FILLED RADIATION DETECTOR SCINTILLATOR,” filed on Mar. 26, 2004. This application also claims priority from U.S. Provisional Patent Application Ser. No. 60/458,694, filed Mar. 28, 2003.

### TECHNICAL FIELD

The present invention relates generally to an ionizing radiation detector and is particularly directed to an ionizing radiation detector having a flexible scintillator portion, for use as a product level (or elevation) detector. The invention is specifically disclosed as a flexible scintillator that detects ionizing radiation of the type that uses a liquid scintillation material within a flexible tube, which is operably connected at an end of the tube to a photodetector.

### BACKGROUND OF THE INVENTION

It is well known to use the combination of a radiation source, such as Cesium¹³⁷ and an elongated radiation detector as a device for measuring the level (or elevation) of material, such as contained within a tank, that is situated between the radiation source and radiation detector. Such devices are particularly useful when the material being measured or the environment in which it is located are particularly caustic, dangerous, or otherwise not amenable to traditional level measurement devices. The types of radiation commonly used for such detectors includes gamma rays and X-rays, typically in the shorter or shortest wavelengths of electromagnetic energy.

Early continuous level detection devices used an ion chamber detector. For example, the ion chamber could be a three to six inch (7.5-15 cm) diameter tube up to 20 feet (6 meters) long filled with inert gas pressurized to several atmospheres. A small bias voltage is applied to a large electrode inserted down the center of the ion chamber. As gamma energy strikes the chamber, a very small signal (measured in picoamperes) is detected as the inert gas is ionized. This current, which is proportional to the amount of gamma radiation received by the detector, is amplified and transmitted as the level measurement signal.

It should be noted here that a “continuous” level detector is one that is capable of measuring multiple discrete steps of the product level (or elevation), or the “continuous” level detector has an analog output that truly provides a virtually infinite resolution of output states that represent the product level (elevation). Such “continuous” level detectors also are typically able to make such level measurement over a long period of time, i.e., continuously, and provide their output signals throughout that long period of time (as opposed to only gathering data during a short time interval). Some conventional level detectors are not at all “continuous,” and merely use multiple “local point” sensors that are able to determine whether a product material has risen to a sufficient level at the location of that individual local point sensor. Several such local point sensors might be used in a spaced-apart arrangement along the side of a tank, and thereby could inform a control system that the product level has reached certain “local points,” but not other “local points.”

Alternatively, elongated scintillation detector “crystals” have been used. Such devices are many times more sensitive than ion chambers and are also considerably more expensive. This added expense is often acceptable because it allows the use of either a smaller radiation source size or to obtain a more sensitive gauge. When gamma energy hits the scintillator material, it is converted into electromagnetic energy, either as visible or invisible (e.g., as ultraviolet or UV) flashes comprised of photons (particles of light). These photons increase in number as the intensity of gamma radiation increases. The photons travel through the scintillator medium to a photomultiplier tube, which converts the light photons into an electrical signal. In a typical photomultiplier tube, the output signal is directly proportional to the gamma radiation energy that is striking the scintillator.

Both conventional ion chamber detectors and conventional scintillation counter detectors have the disadvantage of being quite rigid in structure. In some applications, such as extending the detector vertically around a horizontally-oriented tank, or along the length of a tank where the shape of the tank or obstructions which are on or part of the tank, limit or prevent the use of such rigid detectors. Thus there is a need for a scintillation counter detector that is flexible so that it may be adapted in the field to bend around such obstacles.

Fiber optic cables made of many individually clad strands of scintillator material have been presented as a conventional solution to this problem. An example of this is shown in U.S. Pat. No. 6,198,103. The required individual cladding of these fibers, however, makes such a solution undesirably costly. Another example of a flexible scintillation crystal detector is shown in U.S. Pat. No. 6,563,120, issued May 13, 2003, which is commonly-assigned to Ronan Engineering Company.

Other conventional scintillating detectors have been available with a liquid scintillating material, but these devices have been used to detect particles such as neutrons, which is not an ionizing radiation. Moreover, such neutron detectors have been merely used to detect radiation from fissionable material, and are not used to detect the physical elevation of a product contained within a tank.

Numerous factors contribute to the advantages of a liquid flexible radiation detector over a solid plastic detector for certain commercial uses. Typically, the requirements for level or elevation measurements in the process industry are a substantially long length (up to 240 inches, 610 cm), a relatively high light output from the solid crystal material (in the conventional detectors), a stability of the output signal versus temperature changes, and a relatively high sensitivity to detecting the desired radiation (which is also referred to as the “efficiency” of the detector).

On fairly long detectors, where the measurement range exceeds about eight (8) feet (244 cm), installation becomes more difficult for solid (i.e., rigid) crystal detectors. Even if the detector's outer protection housing is made of PVC, the weight of a 2″×2″ square PVT crystal that is 96 inches (244 cm) long is relatively heavy, and also the length is cumbersome to manipulate, especially since it may have to be mounted ten (10) feet (305 cm) or more above the ground.

There are times when obstacles are encountered, such as reinforcement rings or other irregular shapes which can be found on the vessels that are being measured, with respect to the level (or elevation) of material within the vessel. In some cases, multiple solid crystal detectors are required to fit a contour of certain vessels, as described (for example) below in reference to FIG. 11. Solid crystals can be used with horizontal round tanks, but the crystal would first need to be heated and formed to the circumference of the tank or vessel. However, the labor cost required to form the crystal and the cost of custom outer pre-formed tubing is essentially prohibitive.

Moreover, the use of multiple solid detectors that are mounted somewhat away from the vessel to clear obstacles sometimes requires that the detectors be mounted in an average plane parallel to the process that is being measured, and often requires some form of linearization to correct for this type of configuration. The attenuation length of PVT (polyvinyl tolulene) crystals can also become a hindrance at longer lengths. A typical attenuation length of PVT crystal material is about three (3) meters, which means that beyond a length of three meters, at least 40% of the light output of the detector is lost. This limits the practical length of PVT-based detectors to about fifteen (15) feet (457 cm) maximum. In such a situation, the gamma radiation source is usually mounted toward the top of the measurement range, and the “long” detectors can be installed upside-down to improve the response at the bottom end of the detector.

Some of the solid PVT crystal detectors are placed in schedule 40 iron pipes, and the weight of such detectors is about fifteen pounds per foot (22.3 kg/m). This type of installation has been required when the solid level detector must be further protected from contact by people or objects, or in hazardous environments that require explosion-proof housings.

It would be an improvement to provide a scintillation detector for level or elevation detection applications that solves many of the problems listed above, including a lower weight, a lower cost, a flexible detector apparatus that can be more easily installed, and a detector that has a longer attenuation length.

### SUMMARY OF THE INVENTION

Accordingly, it is an advantage of the present invention to provide a flexible ionizing radiation-type level (or elevation) detector in which an elongated flexible tube is filled with a liquid scintillator material. The flexible tube has first and second ends, at least one of which is aligned for operable connection to a photodetector. Such a scintillator is flexible in three dimensions.

It is another advantage of the present invention to provide a flexible ionizing radiation-type level/elevation detector that has an elongated flexible tube that is filled with a liquid scintillator material, in which the flexible detector has a much lower weight than previous solid scintillator crystal detectors.

It is yet another advantage of the present invention to provide a flexible ionizing radiation-type level/elevation detector that uses an elongated flexible tube filled with a liquid scintillator material, in which this level detector has an attenuation length greater than three (3) meters, and preferably at least five (5) meters.

It is still another advantage of the present invention to provide a flexible ionizing radiation-type level/elevation detector that uses an elongated flexible tube filled with a liquid scintillator material, in which the index of refraction of the liquid scintillator material is at least 1.4, and the index of refraction of the flexible tube material is less than 1.4.

It is a further advantage of the present invention to provide a flexible ionizing radiation-type level/elevation detector that uses an elongated flexible tube filled with a liquid scintillator material, in which the tubing size and outer sheath material allows for a bending radius as low as twelve (12) inches (30 cm).

It is yet a further advantage of the present invention to provide a flexible ionizing radiation-type level/elevation detector that uses an elongated flexible tube filled with a liquid scintillator material, in which the flash point of the liquid scintillator material is greater than 93° C., and in which the flexible tubing can withstand and remain stable and flexible over process temperature ranges of −50° C. to +80° C.

It is still a further advantage of the present invention to provide a flexible ionizing radiation-type level/elevation detector that uses an elongated flexible tube filled with a liquid scintillator material, in which the weight of the liquid-filled level detector is about 1.5 pounds per foot (2.23 kg/m).

Additional advantages and other novel features of the invention will be set forth in part in the description that follows and in part will become apparent to those skilled in the art upon examination of the following or may be learned with the practice of the invention.

To achieve the foregoing and other advantages, and in accordance with one aspect of the present invention, a product level detector system apparatus is provided, which comprises: a container that holds a mass, the container having a first surface portion and a second surface position; an elongated flexible tubular member that is physically located at the first surface portion of the container, the tubular member having a first closed end and a second closed end, the tubular member having an interior region that is substantially filled with a liquid scintillation material which is sensitive to detecting ionizing radiation; a photosensitive device located near the first closed end of the tubular member, the photosensitive device detecting scintillating photons generated in the scintillation liquid that are indicative of ionizing radiation passing into the liquid scintillation material, the photosensitive device generating an output signal that is related to a quantity of the scintillating photons; a ionizing radiation source that is physically located at the second surface position of the container; and an electrical detection circuit that determines a relative elevation of the mass being held by the container, based upon a value of the output signal of the photosensitive device.

In accordance with another aspect of the present invention, a product level detector is provided, which comprises: an elongated flexible tubular member that has a first closed end and a second closed end, the tubular member having an interior region that is substantially filled with a liquid scintillation material which is sensitive to detecting ionizing radiation; the liquid scintillation material reacting to ionizing radiation passing into the liquid scintillation material by generating scintillating photons, the ionizing radiation being of a first wavelength and the scintillating photons being of a second, different wavelength, the ionizing radiation arriving at first angles that are not parallel to a longitudinal axis of the tubular member, and the scintillating photons being directed along the interior region of the tubular member at different second angles, thereby effectively providing lateral coupling between the ionizing radiation and the scintillating photons; and a photosensitive device located near the first closed end of the tubular member, the photosensitive device detecting the scintillating photons and generating an output signal that is related to a quantity of the scintillating photons.

In accordance with yet another aspect of the present invention, a product level detector is provided, which comprises: an elongated flexible tubular member that has a first closed end and a second closed end, the tubular member having an interior region that is substantially filled with a liquid scintillation material which is sensitive to detecting ionizing radiation; and a photosensitive device located near the first closed end of the tubular member, the photosensitive device detecting scintillating photons generated in the scintillation liquid that are indicative of ionizing radiation passing into the liquid scintillation material, the photosensitive device generating an output signal that is related to a quantity of the scintillating photons; wherein: (a) the liquid scintillation material has an index of refraction greater than or equal to (>) 1.4, a thermal flash point temperature greater than (>) 93° C., a light output characteristic greater than or equal to (>) 50%, and an attenuation length greater than (>) 3 meters; and (b) the elongated flexible tubular member has an index of refraction less than (<) 1.4.

In accordance with still another aspect of the present invention, a method of installing a product level detector is provided, in which the method comprises the following steps: (a) providing a product level detector apparatus with an elongated flexible tubular member having a first closed end and a second closed end, and an interior region that is substantially filled with a liquid scintillation material which is sensitive to detecting ionizing radiation; and a photosensitive device located near the first closed end of the tubular member, the photosensitive device detecting scintillating photons generated in the scintillation liquid that are indicative of ionizing radiation passing into the liquid scintillation material, the photosensitive device generating an output signal that is related to a quantity of the scintillating photons; (b) providing a container that holds a mass; (c) coiling the tubular member in a convenient carrying position for a person who will perform an installation of the product level detector apparatus; (d) climbing, with the tubular member wrapped around the person's body, to a location at which the product level detector apparatus is to be installed; and (e) mounting the product level detector apparatus to a surface of the container, after which the product level detector apparatus will be positioned to detect a relative elevation of a product within the container, within a desired range of product elevation detection.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a segmented longitudinal sectional view of a radiation-type level detector which includes a flexible liquid scintillator according to a preferred embodiment of the invention.

FIG. 2 is a detail longitudinal sectional view showing the detector head housing.

FIG. 3 is a detail longitudinal sectional view of the interface between the flexible liquid scintillator and photo multiplier tube/head according to one preferred embodiment of the present invention.

FIG. 4 is a detail longitudinal sectional view showing a variable volume end expansion chamber according to one preferred embodiment of the present invention.

FIG. 5a is a detail longitudinal sectional view showing another preferred embodiment showing a connection between the flexible liquid scintillator and head assembly.

FIG. 5b is a detail longitudinal sectional view showing a variable volume end expansion chamber according to another preferred embodiment of the invention.

FIG. 6a is a detail longitudinal sectional view showing another preferred embodiment showing a connection between the flexible liquid scintillator and head assembly.

FIG. 6b is a detail longitudinal sectional view showing a variable volume end expansion chamber according to another preferred embodiment of the invention.

FIG. 7 is a sectional view showing an alternate expansion chamber design.

FIG. 8 is an elevational view in cross section of a storage tank level sensing installation, in which the flexible level sensor of the present invention is placed along the cylindrical outer surface of the storage tank, thereby detecting the level (or elevation) of a material contained within the storage tank.

FIG. 9 is a cross-section view of an exemplary embodiment of the flexible tubular portion of the flexible liquid scintillator of the present invention.

FIG. 10 is an elevational view in cross section of the storage tank level sensing installation of FIG. 8, in which a liquid material is contained within the storage tank, and some of the gamma radiation emission lines are attenuated by that liquid material before reaching the flexible liquid scintillator of the present invention.

FIG. 11 is an elevational view in cross section of a prior art storage bin level sensing installation, in which the storage bin is funnel shaped at its bottom portion; two conventional level sensors each having a solid scintillator are placed along the storage bin's outer surfaces and are used to detect the level (or elevation) of material contained within the storage bin.

FIG. 12 is an elevational view in cross section of a storage bin level sensing installation, in which the storage bin is funnel shaped at its bottom portion; a single flexible level sensor of the present invention is placed along the storage bin's outer surfaces and, having a flexible liquid scintillator portion, is used to detect the level (or elevation) of material contained within the storage bin.

FIG. 13 is an elevational view in cross section of a prior art storage bin level sensing installation, in which the storage bin is shaped like a vertically-oriented cylinder, and has a connecting flange along its outer surface; two conventional level sensors each having a solid scintillator are placed along the storage bin's outer surfaces and are used to detect the level (or elevation) of material contained within the storage bin.

FIG. 14 is an elevational view in cross section of a storage bin level sensing installation, in which the storage bin is shaped like a vertically-oriented cylinder, and has a connecting flange along its outer surface; a single flexible level sensor of the present invention is placed along the storage bin's outer surfaces and, having a flexible liquid scintillator portion, is used to detect the level (or elevation) of material contained within the storage bin.

FIG. 15 is a sectional view showing a further alternative expansion chamber design, which includes a bellows.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

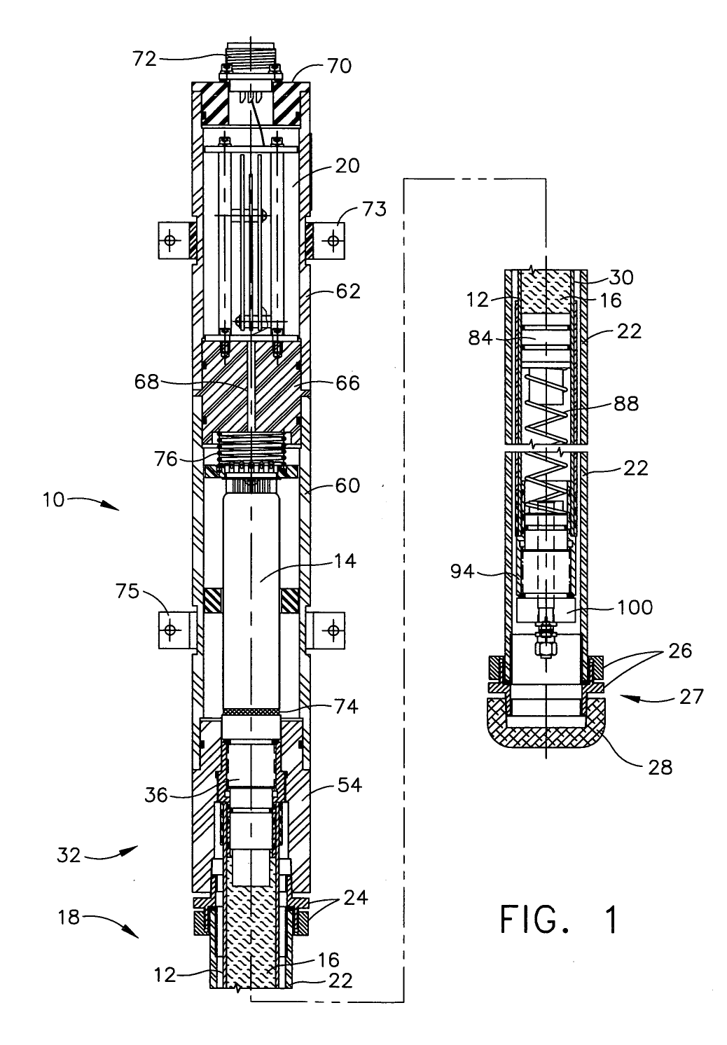

Referring now to the various figures of the drawing, and first to FIG. 1, therein is shown at 10 a flexible radiation-type level detector according to one preferred embodiment of the present invention. The device 10 includes a flexible tube 12 operably connected at an end to a photo multiplier tube 14 which acts as a photodetector. The flexible tube 12 includes a liquid scintillator material 16 which, when hit with gamma radiation energy, produces flashes comprised of light photons (particles of light), typically in the UV (ultraviolet) spectrum. The tube 12, substantially filled with liquid scintillation material 16, comprises the scintillator 18, collectively.

The scintillator 18 is operably connected to a photo multiplier tube 14 of well-known construction. The quantity of light photons produced by the scintillator 18 is directly proportional to the quantity of gamma radiation energy that is striking the liquid scintillation material 16. Likewise, the output of the photo multiplier tube 14 is directly proportional to the number of photons it detects from the scintillator 18. The device 10 further may include an electronic amplifier 20, also of well-known construction, which produces a signal output in 10 volt pulses.

In preferred form, the flexible tube 12 may be made from any of a variety of materials having sufficient flexibility, strength and chemical resistance to the liquid scintillation material 16 being used. A one inch (2.54 cm) inside diameter is preferred, but tubing from one-fourth inch (0.635 cm) to four inches (10 cm) inside diameter may be employed for various applications. A preferred tubing material is a fluoropolymer plastic that sold by Norton Performance Plastics Corporation, of Wayne, N.J. under the trademark CHEMFLUOR. It has been found that CHEMFLUOR formulation 367 in one inch (2.54 cm) inside diameter has the desired index of refraction and internally smooth walls to enhance internal reflection. An acceptable fluoropolymer tubing is also sold by the same company under the trademark TYGON. The tubing materials discussed above are not TEFLON derivatives, nor TEFLON itself.

A large variety of liquid scintillation material is available from either Bicron Business Unit (d.b.a. Bicron) of Saint-Gobain Industrial Ceramics, Inc. in Newbury, Ohio or Eljen Technology of Sweetwater, Tex. Acceptable materials manufactured by Bicron are sold under the catalog listing BC-599-16, BC-517H, or BC-517L. Acceptable materials made by Elgin Technology are denoted EJ-321H or any of the EJ-399 series (04, 06, 08, 09). In selecting a liquid scintillation material, one should choose the desired balance between light output and flash point. That is, some material having a lower flash point (74° C.-81° C.) have higher light output (66%-52%, respectively). Materials having a higher flash point (>150° C.) provide lower light output (50%). If a higher flash point is required due to the environment in which the device 10 will be used, the choices of liquid scintillation material are more limited. For this reason, use of the Bicron BC-599-16 product, having a flash point of 167.1° C., is preferred.

All of the examples of liquid scintillation material described above have a refractive index greater than the refractive index of the tubing 12. These liquid scintillation materials typically emit light in the range of 425 nm (which is in the ultraviolet band of wavelengths). This range is easily compatible with commercially available photo multiplier tubes. It will be understood that the present invention will readily work with liquid scintillation materials that emit electromagnetic energy (photons) at wavelengths other than 425 nm, including wavelengths in the visible band of colors.

In preferred form, the entire scintillator 18 is encased in another flexible tubular casing or sheath 22. A product deemed suitable for this purpose is sold by Electri-flex Company of Roselle, Ill. under the trademark LIQUATITE®. This material is a spiral-wound metallic conduit that is covered with a water-tight/light-tight plastic sheath. Other types of water-tight/light-tight flexible tubing may also be suitable. A one and one-quarter inch (3.17 cm) inside diameter flexible casing 22 is appropriate for covering a one inch (2.54 cm) inside diameter scintillator tube 12 and can provide a flex radius as small as 12 inches (30 cm) or less. Threaded couplings 24, 26 specifically designed for use with the material of the outer casing 22 should be attached in a water-tight/light-tight manner at each end. The free end 27 may then be closed with a typical threaded cap 28.

Some care should be used when selecting the materials for the innermost tubing 12 and the outer sheath 22 materials. Some of the smaller sizes suitable tubing 12 may tend to kink if the minimum bending radius limitation is not observed when the scintillator 18 is installed on a jobsite. For example, if the CHEMFLUOR 367 tubing is coiled or bent beyond a three-foot diameter, it might kink unless an outer jacket is used to prevent this from occurring. The outer jacket discussed above will substantially prevent kinking for a bend that may be as low as a one-foot bend radius. For the CHEMFLUOR 367 tubing to kink, it must first begin to flatten. The flexible sheath discussed above has an internal metal coil that provides a structurally circular reinforcement to help keep the tubing from flattening (and thus kinking). The inside diameter of the sheath can be selected to closely surround the outer diameter of the tubing, to enhance these characteristics. A cross-section view of an exemplary scintillator tube sub-assembly is provided on FIG. 9, which is discussed below in greater detail.

Between the scintillator tubing 12 and the outer casing 22, the flexible tube 12 is wrapped with at least one layer of an appropriate low friction, and light-reflecting material 30. It has been found that a foil or mirror-finish material is not required. Instead, simply using a white material that provides abrasion resistance for contact between the inner and outer tubes 12, 22 spirally taped in place, is sufficient. This material 30 also can serve as a “gap-filler” to ensure that the flexible inner tubing cannot flatten enough to cause kinking. (See reference numeral 254 on FIG. 9.) An appropriate material has been found to be spunbonded olefin sheet products such as TYVEK® made by DUPONT® Type 14.

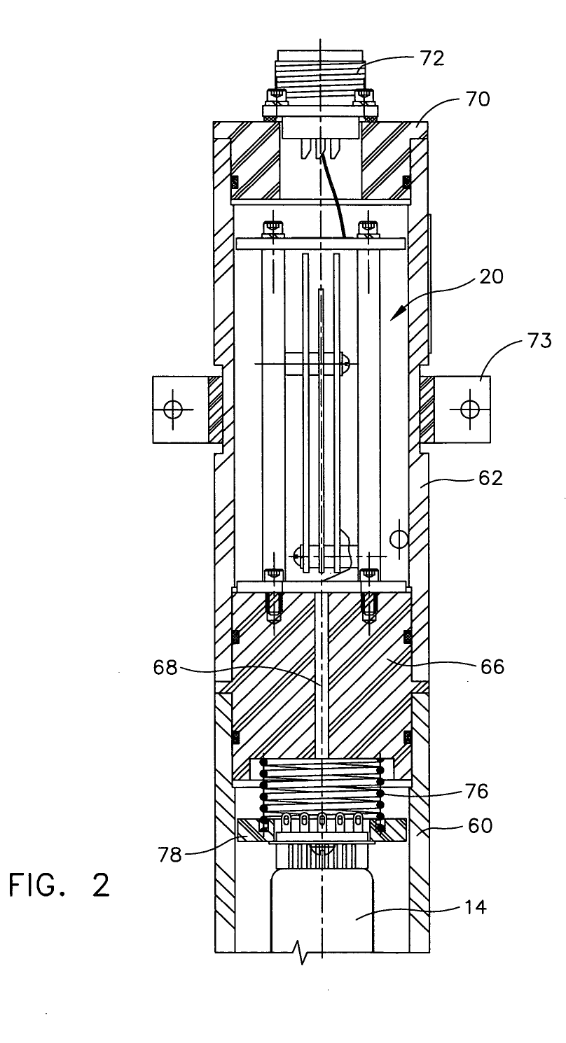

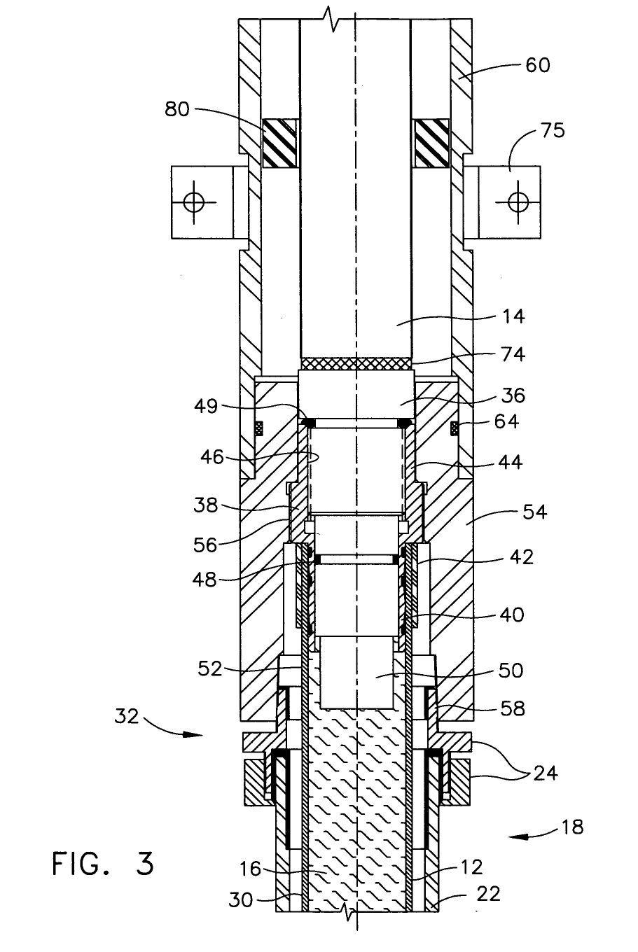

Referring now also to FIGS. 2-4, and particularly to FIG. 3, it can be seen that the detector end 32 of the scintillator 18 is securely closed by an optically transparent plug member 36. This plug member 36 is preferably made of acrylic or similar suitable material such as glass, LEXAN™, or PLEXIGLASS™. The selected material should be chemically inert to the liquid scintillation material 16 and have an index of refraction similar to that of the liquid scintillation material 16.

An end plug mounting member 38 is fixedly joined to the flexible tube 12. This member 38 is preferably turned from stainless steel and includes an end portion 40 which is sized to frictionally engage the inner surface of the flexible tube 12. An attachment ring or collet 42 made of a softer metal, such as copper, is then crimped or swaged into place over the flexible tube 12 to create a secure connection. The mounting member 38 includes an internally threaded portion 44 which engages an externally threaded portion 46 of the transparent end plug 36. Elastomer o-rings 48, 49 provide a seal on both sides of the threaded engagement.

An inner end portion 50 of the transparent closure plug 36 has a reduced diameter portion which may extend axially a length equivalent to at least the inside diameter of the flexible tubing 12. This provides an annular interior chamber 52 in which any minute bubbles may accumulate without significantly degrading the passing of light from the liquid scintillation material 16 through the end plug 36. It is expected that the detector end 32 of the scintillator 18 will be mounted at the highest point of the detector 10 installation. Such mounting is not required and the annular internal chamber 52 may not be necessary if the detector 10 is mounted such that the photo-detection head is always situated at the lowest point of the scintillator 18.

The detector end 32 of the scintillator 18 may be rigidly secured in a head block 54, made of either metal or a suitable polymer material, by a mutual threaded engagement 56. The head block 54 provides a rigid mounting of the detector end 32 of the scintillator 18 that is of sufficient length to protect the seal between the transparent plug 36 and the flexible tube 12 from damage due to over-flexing. The threaded coupling 24 of the outer protective casing 22 may be firmly secured by threaded engagement 58 with the head block 54.

The head block 54 also provides a rigid and water tight connection between the scintillator 18 and housing members 60, 62 that enclose the photo multiplier tube 14 and electronic amplifier 20. A water tight connection between the head block 54 and photomultiplier tube housing 60 is provided by an elastomeric o-ring 64 or other seal. An internal ring 66 connects the housing portions 60, 62 and provides an internal passageway 68 for wiring between the photo multiplier tube 14 and amplifier 20. A water tight end plug 70 closes the end opening of housing 62 and provides the mounting for an industry standard water tight electrical connector 72. If desired, mounting flanges 73, 75 may be used for field installation of the detector housing 60, 62.

An interface between the photo multiplier tube 14 and optically clear end plug 36 may be facilitated with a transparent elastomer disk or pad 74. A preferred silicone elastomer material is SYLGARD® 184 manufactured by Dow Corning. In preferred form, the photo multiplier tube 14 is spring biased to bear against the pad 74 and end plug 36 so that a close contact is constantly maintained. It is also preferred that the photo multiplier tube 14 be spring biased 76 in the axial direction into firm contact with the elastomer pad 74. The spring 76 maintains close operable contact without regard to physical orientation of the device 10, temperature fluctuations, or impact from external forces. One or more centering rings 78, 80 maybe used to maintain lateral alignment of the photo multiplier tube 14 within the housing 60.

The liquid scintillation materials 16 presently available have a relatively high coefficient of thermal expansion. For this reason, volumetric expansion of the liquid scintillation material 16 must be accommodated. Additionally, even at steady temperatures, the total volume of the flexible tube 12 will change, to a lesser degree, as the scintillator 18 is coiled for shipment or bent during installation. If volumetric expansion is not otherwise accommodated, the integrity of the fluoropolymer material of the tube 12 can be compromised and fatigue bubbles or other deformations may be introduced into the wall of the tube 12 which otherwise compromises its desired index of refraction or the internal smoothness of the walls that enhances internal reflection.

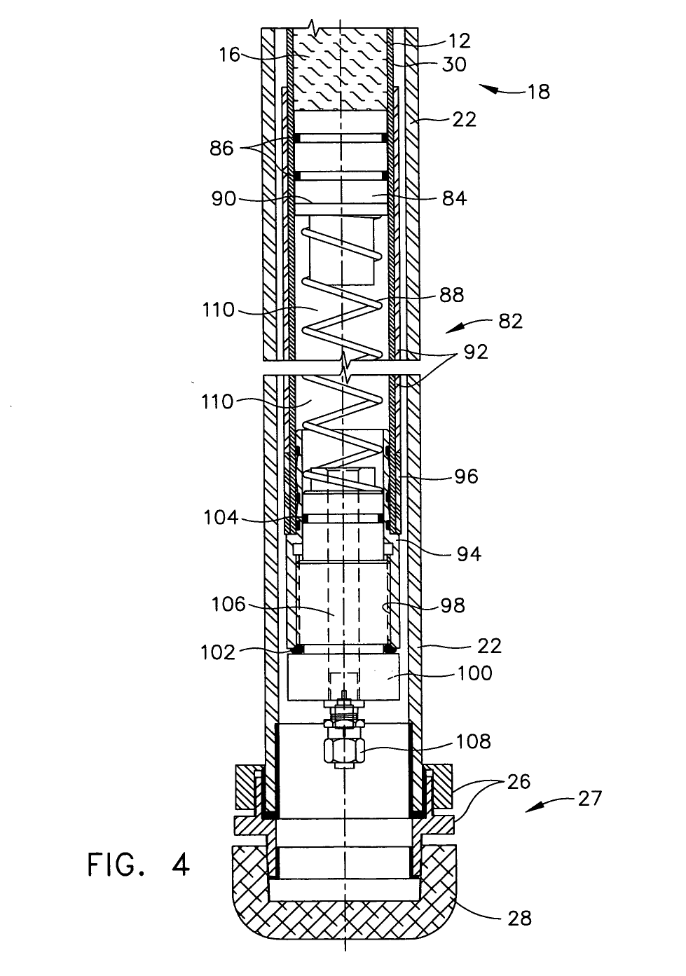

Accordingly, referring now particularly to FIG. 4, therein is shown generally at 82 a variable volume expansion chamber means substantially at the free end 27 of the scintillator 18. This may include a piston member 84 sized to slidably fit within the flexible tube 12 and sealed with one or more elastomer o-rings 86 or spring loaded TEFLON seals. The piston member 84 may be spring biased 88 against the liquid scintillation material 16. The piston member 84 is preferably made of acrylic or other transparent material similar to that of the end plug member 36 and includes a foil layer or other light-reflecting material on its surface 90 opposite that exposed to the liquid scintillation material 16.

In order to provide free movement of the piston member 84, an elongated, cylindrical stiffening tube 92, preferably made from stainless steel or aluminum, is placed over a portion of the flexible tube 12, external of the reflective layer 30, to provide a relatively axially straight guide for the piston 84 along a predetermined length portion of the scintillator 18.

The free end 27 of the scintillator 18 is enclosed using a coupler 94 friction swaged into place by a collet 96 in a manner similar to that shown in FIG. 3 for the detector end of the scintillator 18. In preferred form, the coupler is turned from stainless steel material and is internally threaded 98 to receive an end plug member 100 with one or more internal elastomer o-ring seals 102, 104. The end plug 100 provides a solid head against which the spring 88 can bear its axial forces biased against the piston member 84. If desired, the plug 100 may include a central passageway 106 and a valve 108 through which an inert gas, such as nitrogen or argon, may be introduced into the gas chamber 110 behind the piston 84. In this manner, the force of the spring 88 against the piston 84 may be either enhanced or reduced by a adjusting the pressure within this chamber 110.

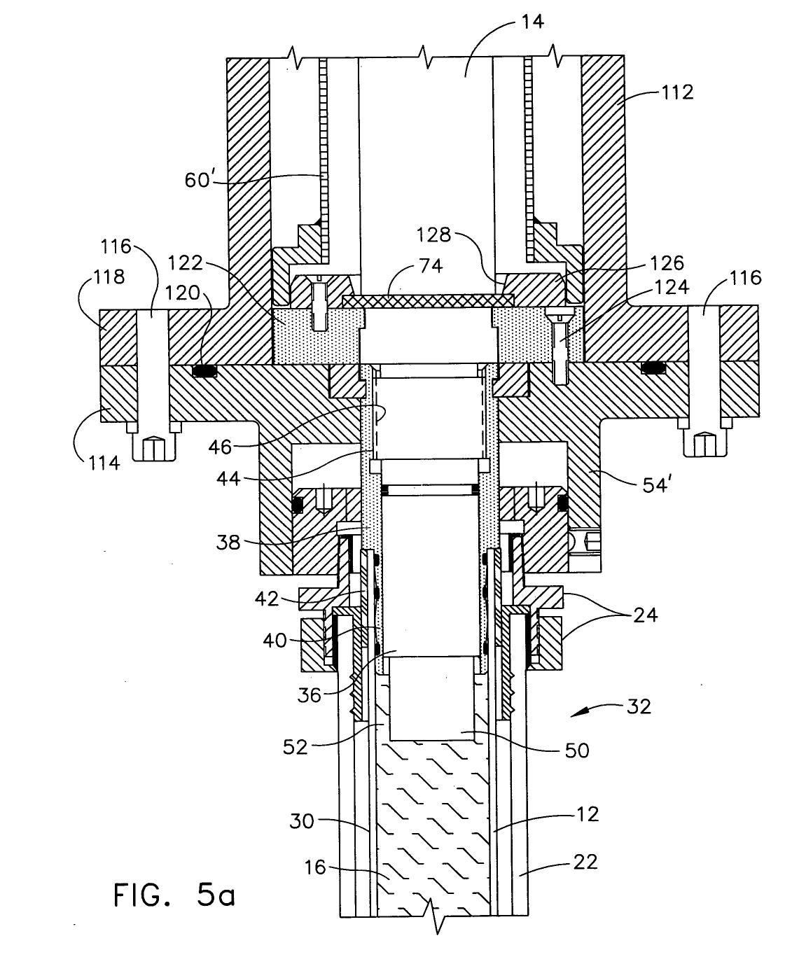

The volumetric expansion chamber system shown in FIGS. 1 and 4 has been found to be suitable only for use in installations where significant ambient temperature fluctuations do not exist and where the portion of the flexible tube 12 reinforced by the stiffener 92 can be maintained free of lateral forces. For this reason, alternate designs for volumetric expansion chambers, shown specifically in FIGS. 5b, 6b, 7, and 15 are disclosed and will be described in detail below.

Referring now to FIGS. 5a and 5b, therein is shown another preferred embodiment of the present invention. In this embodiment, the construction of the scintillator 18 portion of the device is substantially the same as that shown and described above. Like reference numerals are used to refer to equivalent parts in these figures for simplicity.

FIG. 5a shows a preferred version of the detector head which includes a head block 54′ that mates with an external housing 112 that is designed according to industry standards to provide a substantially “explosion proof” enclosure. The head block 54′ receives the transparent end plug 36 and couples to the outer casing or sheath 22 in substantially the same way as the first embodiment described above. The head block 54′ may include a substantial annular flange 114 that couples via bolts 116 to a flange 118 that is part of the explosion proof outer housing 112. An elastomeric o-ring seal 120 may be provided to include a water tight coupling. Within the outer housing 112 there is an inner housing 60′ which encloses the photo multiplier tube 14 and amplifier (not shown in this figure) in substantially the same way that housing parts 60, 62 function in the above-described embodiment.

In this embodiment, the stainless steel coupler 38 and transparent end plug 36 are mounted to the head block 54′ with a first annular mounting ring 122 which may be removably bolted 124 in place. The transparent elastomeric disk 74 is mounted to the first annular ring by a second annular mounting ring 126. In preferred form, this ring 126 includes a substantially funnel-shaped opening 128 to guide the photo multiplier tube 14 into place as it is axially inserted, along with the inner housing 60′, when the detector head is assembled.

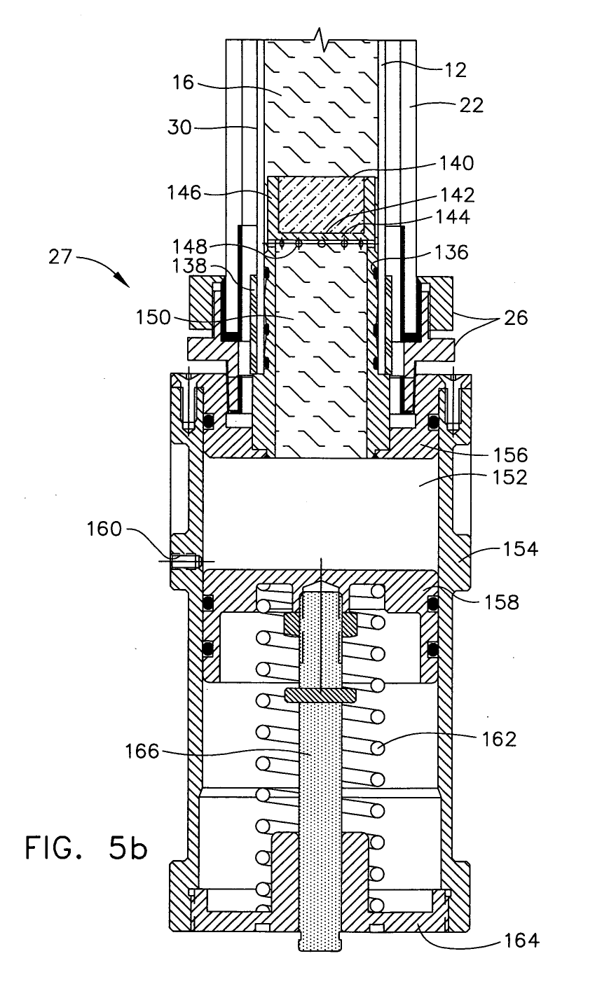

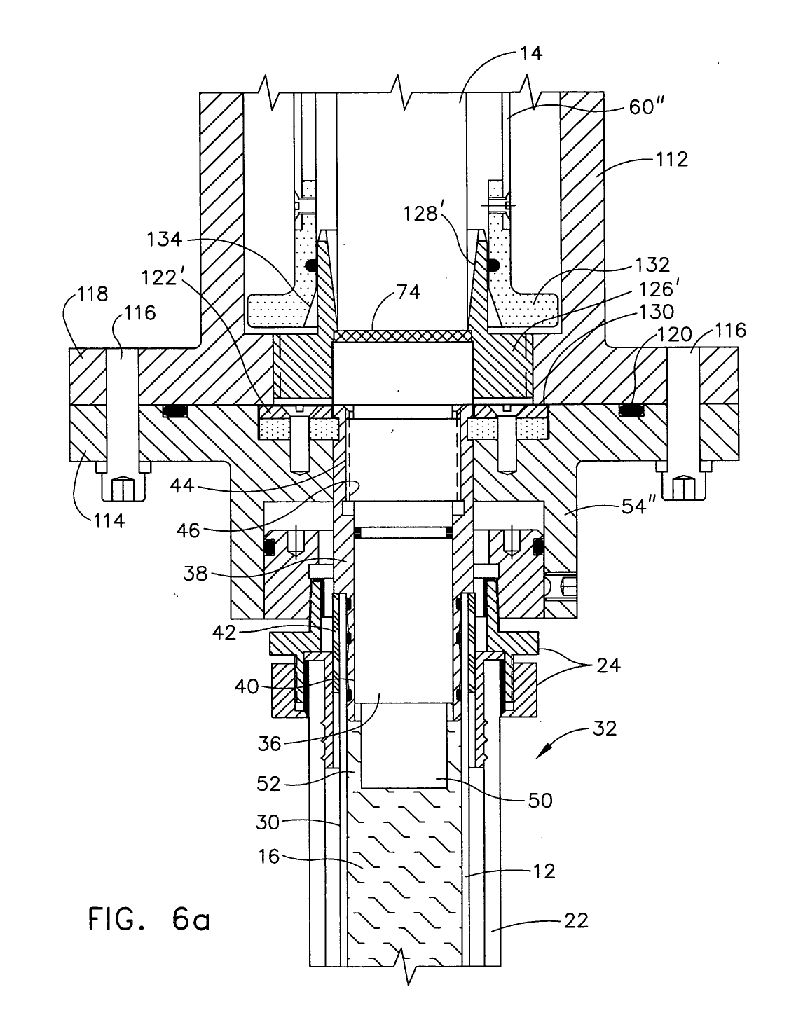

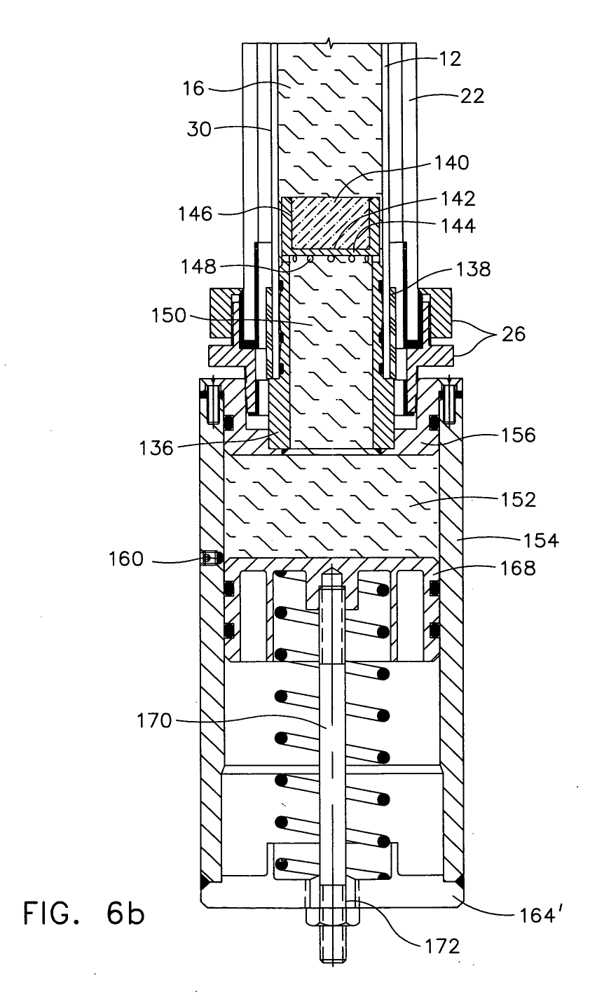

FIG. 6a shows a design similar to that shown in FIG. 5a, with some variation in the manner of attachment between the coupling 38 and transparent end plug 36 to the head block 54″. In this embodiment, a first mounting ring 122′ secures the coupling 38 to the head block 54″. Attachment of the outer housing 112 to the head block 54″ further secures this mounting due to the overlapping position of an inner flange 130. The second annular mounting ring 126′ includes an axially-elongated guide funnel 128′ to receive the axially-inserted photo multiplier tube 14 and to retain the transparent elastomer cushion 74 in place against the transparent end plug 36. An end member 132 for the inner housing 60″ includes external flange portions for correctly positioning it within the outer housing 112 and an internal bevel 134 to help guide it in place around the second annular ring 126′ during assembly.

FIGS. 5b and 6b show alternate volumetric expansion systems. In each of these preferred embodiments, an expansion chamber is provided that is external to the flexible tube 12 and, therefore, may be less susceptible to malfunction.

Referring to FIG. 5b, the free end of the flexible tube 12 is secured to a coupling 136 made of stainless steel or similar material and sized to friction fit the internal circumference of the flexible tube 12. The coupling is then secured by an outer collet 138 made of copper or similar relatively softer material that is crimped or swaged into place. The coupling 136 includes a plug 140 of acrylic or similar material bonded in place over a reflective film or disk 142 against an end wall 144. An end portion 146 of the coupling 136 is reduced in diameter to allow an annular bypass of liquid scintillation material 16 around it and to be in fluid communication with a series of radial openings 148 in the coupling 136. These radial openings 148 allow fluid communication between the interior of the flexible tube 12 and an interior passageway 150 of the coupling 136. This passageway, in turn, leads to a variable volume expansion chamber 152.

In the illustrated embodiment, the position of the reflector does not change with volumetric expansion and contraction. This arrangement maintains a substantially constant active length (the distance between the photomultiplier tube and reflector) and consequently reduces measurement errors.

The expansion chamber 152 is defined by a cylinder housing 154, a closure head 156, and an axially moveable piston member 158. Both the coupling member 136 for the flexible tube 12 and the coupling 26 for the outer casing 22 attach to the head member 156. The cylindrical housing 154 may be provided with a bleed hole 160 to the expansion chamber 154. The piston 158 is spring biased 162 against the liquid scintillation material 16 in the expansion chamber 52. The spring 162 is held in place by annular guides formed in the piston 158 and closure head 164. A guide rod 166 may also be provided which allows the piston 158 to be locked in an axial position while the scintillator 18 is being filled. After the entire internal chamber of the flexible tube 12 and expansion chamber 152 have been filled, any remaining gas bubbles are bled off and the guide rod 166 is released to allow the piston 158 to float freely as the liquid scintillation material 16 expands or contracts.

Referring now to FIG. 6b, an alternate piston design 168 is shown. Additionally, it is provided with a guide rod 170 that may be threaded 172 in place in the second head closure member 164′ for filling of the scintillation chamber. Thereafter, the guide rod 170 is completely removed and may be replaced with a simple threaded plug (not shown). In this manner, the potential for undesired friction or seizing caused by the guide rod 170 is eliminated. Additionally, it becomes unnecessary to cover and protect the otherwise exposed end of a dynamic guide rod, such as may be the case with guide rod 166 shown in FIG. 5b.

Referring now to FIG. 7, therein is shown an alternate design for a volumetric expansion chamber positioned adjacent to or integral with the detector head portion of the device 10. In this embodiment, the annular chamber 52 around the reduced diameter portion 50 of the transparent end plug 36 is provided fluid communication, through multiple radial passageways 174, to a first annular expansion chamber 176. This design may be particularly useful for an installation where access to the free end 27 of the scintillator 18 is limited or space-restrained.

It has been found that extreme ambient temperature fluctuations, in addition to causing thermal expansion and contraction of the liquid scintillator material 16 can cause performance fluctuations requiring appropriate measures for compensation. First, when the device is expected to be exposed to relatively low temperatures, use of a heat blanket may be useful for maintaining performance stability of the electronic components (photo multiplier tube and amplifier). In preferred form, an electric heat blanket (not shown) may be situated in the annular space 178 between the inner housing 60, 60′, 60″ and the outer explosion proof housing 112 (See FIGS. 5a, 6a, and 7). Preferably, the heat blanket is set to maintain a constant temperature of approximately 50° C.

Conversely, if the device 10 is to be used in an installation where it will be exposed to widely varying ambient temperatures, performance can be affected when temperatures shift to a higher range. For example, the length of the scintillator 18 can collect a significant amount of heat when exposed to prolonged direct sunlight. This heat is rapidly transferred through the liquid scintillation material 16 and the closure plug 36 to the photo multiplier tube 14. Because such levels of heat do not harm the electronic components of the device 10, but rather merely affect output, it is far simpler to compensate for this shift electronically, or in software of a processing circuit that receives these signals, rather than trying to physically cool the electronic components. On the other hand, using available electrical energy to heat the components when necessary, is relatively easy. By using an internal temperature sensor, commonly already found in the detector head circuitry, simple alteration of software and/or hardware to compensate for high temperature output shift will insure proper linear performance of the device when measuring tank levels and the like. The exact configuration of a compensation program is within the ordinary skill of one in the art.

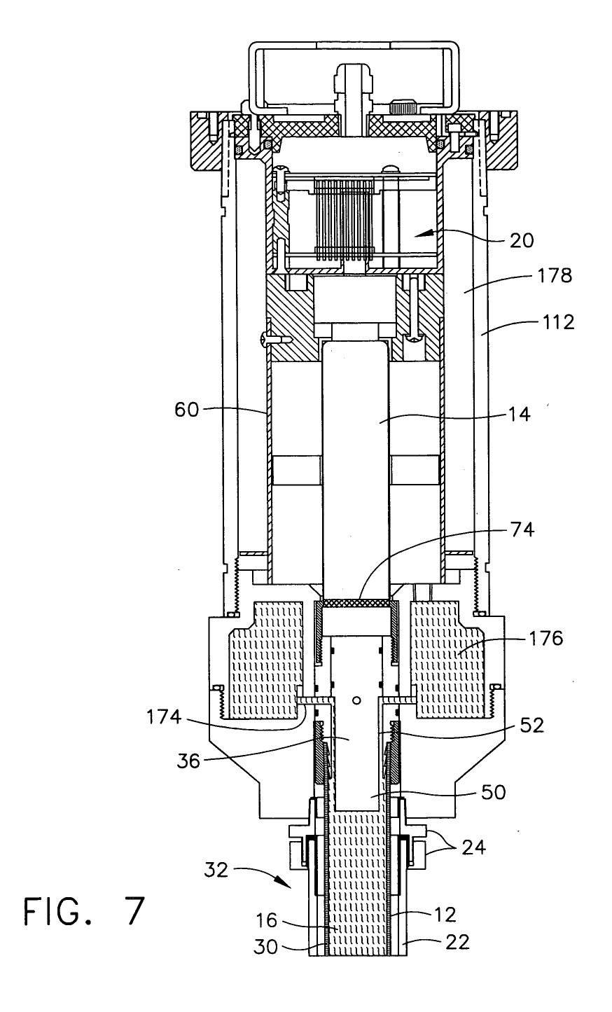

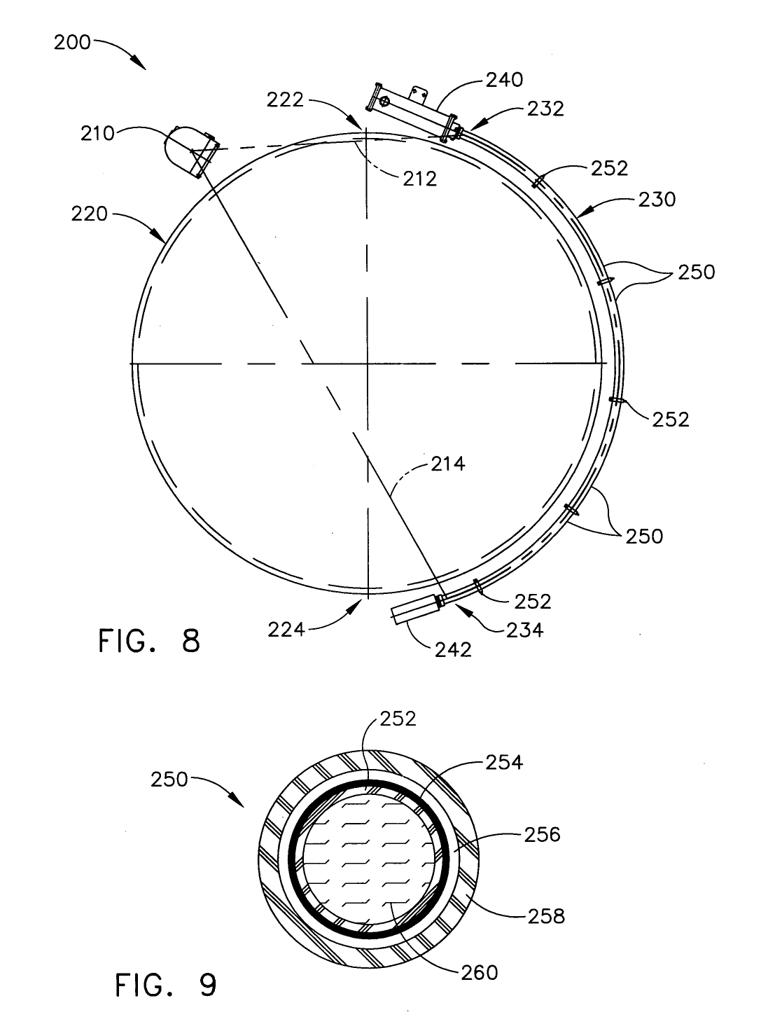

Referring now to FIG. 8, a continuous level detector constructed according to the principles of the present invention is used for detecting the level of an interior volume that is cylindrical in shape. This overall structure is generally designated by the reference numeral 200 in FIG. 8. In this example, it is assumed that the cylindrical container is lying such that its longitudinal direction (i.e., the centerline of the circle as seen in FIG. 8) is substantially horizontal, and a liquid material or a solid material will be filling this interior space from a lowest point at 224 to a highest point at 222. The overall container structure is generally designated by the reference numeral 220, and if desired, this type of structure can generally be referred to as a cylindrical tank.

A radiation source is positioned at 210, which is substantially at the mid-point of the cylindrical tank 220 and, in this view, this would be at the diametral horizontal line that intersects the centerline of the tank. A radiation detector constructed according to the principles of the present invention is generally designated by the reference numeral 230. Level detector 230 has a “sensing end” that includes a receiving portion at 240, which includes a photomultiplier tube for receiving scintillating-type radiation and an electronic amplifier circuit for outputting an electrical signal that is based on the quantity of photons received at the photomultiplier tube.

At an opposite end 242, the level detector structure is terminated, which is also referred to in this patent document as a “free end.” Between the sensing end 240 and the free end 242 is an elongated tubular member 250 that is generally hollow along its entire length, and that hollow volume is substantially filled with a liquid material that acts as the scintillating material which is sensitive to an ionizing radiation, such as gamma rays or X-rays. This tubular material 250 is flexible, which is why it can be easily placed around the arcuate surface of the cylindrical tank 220. In FIG. 8, the tubular member 250 is held in place by several brackets 252.

When viewing FIG. 8, the radiation source 210 is designed to emit an ionizing radiation (such as gamma rays or X-rays) in multiple directions, including along emission lines at 212 and 214. Furthermore, radiation source 210 would typically be designed to emit radiation at virtually all angles between the two emission lines 212 and 214. In this view of FIG. 8, the emission line 212 represents the highest angle that will be detected with regard to the level or elevation of the product material contained within the cylindrical tank 220, while the emission line 214 represents the lowest detecting level (or elevation) of that same material. The illustrated angles of maximum and minimum level (elevation) detection are only a limitation with respect to the installation illustrated in FIG. 8, and it will be understood that the flexible radiation level sensor 230 could readily be configured for different maximum and minimum lines of detection (for different product levels in the tank), if desired.

It should be noted that the use of the word “level” in the previous paragraph represents the highest elevation of the product being detected within the container 220, and is not directly referring to the amount of radiation received (which would be the magnitude or quantity of the radiation from the ionizing radiation source 210). It will be understood that, if a solid or liquid product exists within the container 220, then the emission lines of ionizing radiation at lower elevations will be attenuated by that product, and will not reach the scintillating detector liquid in the tubing at 250.

The emission line 212 intersects the upper-most portion of the flexible tube 250, at a point designated by the reference numeral 232. Emission line 214 intersects the flexible tube 250 at a lower-most detecting point 234. Of course, flexible tube 250 could be extended past these points, and to essentially reach all the way to the very top of the tank at 222 and the very bottom of the tank 224, if desired. Moreover, the flexible tube 250 could be shortened if, for example, the level of the material within the cylindrical tank 220 only needed to be detected at elevations that are not so near to the top 222 of the tank or to the bottom 224 of the tank 220.

Referring now to FIG. 9, a cross-section of the tubular material that makes up the flexible tube 250 is illustrated in greater detail. The innermost layer 252 is made of a material that allows a specific wavelength of the ionizing radiation of interest to pass therethrough, but due to the reflective quality of the inner wall of the tubing, the converted radiation (i.e., the scintillating photons) of a different wavelength are reflected back within the tube itself. As discussed above, one material that could be used for the inner layer 252 of the flexible tube 250 is CHEMFLUOR™.

The innermost layer of tubing 252 is flexible, and should be constructed to retain a scintillating liquid material. This liquid material is designated by the reference numeral 260, and typically would substantially fill the volume within the inner diameter of the innermost tube 252.

On the outer surface surrounding the innermost tube 252 is a layer of insulating material, at 254. In an exemplary mode of the present invention, this material can be TYVEK™, as discussed above. In a preferred mode of the invention, there can be three layers of such TYVEK material surrounding the innermost tube 252.

An outer cylindrical conduit layer 258 surrounds both the innermost tube 252 and the TYVEK layers 254. This conduit 258 is flexible, and should be liquid tight and light tight to protect and shield the tube 252 from the weather elements, and to provide a light-proof environment for the scintillating process.

In an exemplary mode of the present invention, there can be a small gap between the outer diameter of the insulating layer 254 and the inner diameter of the flexible conduit 258. This will allow for greater flexibility of the overall flexible tubular level detector subassembly 230. This gap is depicted at the reference numeral 256 on FIG. 9. In general, the sheath should be relatively tight-fitting.

Referring now to FIG. 10, the continuous level detection system with a cylindrical tank generally designated by the reference numeral 200 is again illustrated, and this time there is a liquid material (product) within a portion of the interior space of the tank 220. This product liquid material is generally designated by the reference numeral 222, and comes up to a level (or an elevation) that is about three-eighths of the entire possible level change within the tank, between the top-most level (elevation) 222 and the bottom-most level (elevation) 224. As in FIG. 8, a radiation source 210 emits radiation in multiple directions, including directions along the lines 270, 271, 272, 273, 274, 275, 276, 277, 278, and 279, on FIG. 10.

The emission line 270 essentially represents the maximum level that can be detected in this configuration, and basically corresponds to the line 212 on FIG. 8; it intersects at the location 232 of the flexible tubular level detector 250. The emission line 279 represents the minimum level that can be detected by the flexible tubular detector 250, as it intersects at the point 234; it essentially corresponds to the emission line 214 on FIG. 8. Again, the use of the word “level” in this paragraph represents the highest elevation of the product being detected within the container 220, and it is not directly referring to the amount of radiation received (which would be the magnitude or quantity of the radiation from the ionizing radiation source 210).

As can easily be seen in FIG. 10, some of the emission lines will have no trouble reaching the flexible tubular level detector 250, and these are the lines 270-275. However, the liquid material 222 will interrupt much of the emitted radiation along the lines 276-279, and thus the flexible tubular level detector 250 will not receive emitted radiation from the radiation source 210 at locations representing those emission lines 276-279. This graphically illustrates the workings of the present invention, since only a portion of the “empty tank” amount of ionizing radiation will be received by the flexible tubular level detector 250 when the contained material 222 exists within the tank 220. When this occurs, there will be less scintillating photons emitted within the flexible liquid-containing tube 250, to be received at the photomultiplier tube and electronics, at the “sensing end” detecting package 240. The relationship between the “full radiation” received in an “empty tank” condition and the “partial radiation” received when there is a product, such as the liquid material 222, within the tank 220 will be a known relationship, and the tank level can then be determined based on the amount of scintillating radiation received at the photomultiplier tube at 240.

One way of describing the flexible level detector of the present invention is that it essentially “laterally couples” the ionizing radiation into the liquid scintillating material within the flexible tube 250. In other words, electromagnetic energy of one wavelength is received at places along the length of the flexible tube 250, and, after penetrating the tube, this ionizing radiation is essentially converted into electromagnetic energy of a different wavelength by the liquid scintillating material within the tube 250, and then that electromagnetic radiation of the “new” wavelength is then further transmitted within the tube's liquid scintillating material 250 until it reaches the photomultiplier tube at 240. This is a new result that has not been achievable by conventional scintillating level detectors, at least not for any type of level (or elevation) detector that uses a liquid scintillating material.

As discussed above, most conventional level detectors use a solid scintillating material, and this solid material cannot possibly bend around a cylindrical tank such as the tank 220, without some major re-work to make it a custom installation. If the bending radius is too small, a solid scintillating material level detector will not be able to be used along the entire length of such a container or tank. In addition, the known conventional solid crystal scintillators have a shorter “attenuation length” than the liquid scintillating material of the present invention. This feature will be discussed in greater detail below.

As noted above, other conventional scintillating detectors have been available with a liquid scintillating material, but these devices have been used to detect particles such as neutrons, which is not an ionizing radiation. Moreover, such neutron detectors have been merely used to detect radiation from fissionable material, and are not used to detect the physical elevation of a product contained within a tank or other type of container. When discussing such neutron scintillating detectors, the word “level” often has been used, but in that application, “level” refers to the amount (or quantity) of neutrons being received by the scintillating material, irrespective of physically where along the liquid material that the neutrons have been received. This type of device is for a different use than that of the present invention, which is used to physically measure an elevation (sometimes called the “level”) of a liquid or solid material (e.g., a product) within a container, such as the cylindrical tank 220 of FIG. 10, not a quantity of neutrons emitted by radioactive decay. Most uses of the present invention do not involve radioactive decay at all, except by the ionizing radiation source, which keeps the radioactive particles contained within its casing, and only emits electromagnetic radiation (e.g., gamma rays) through its casing.

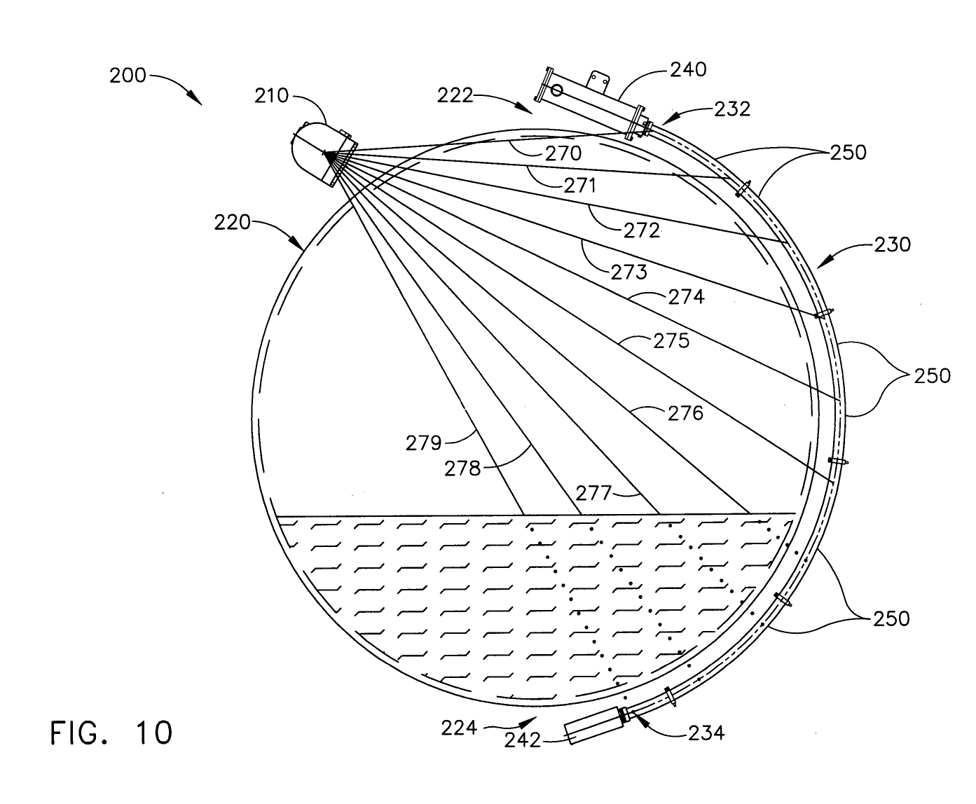

Referring now to FIG. 11, a funnel-type container (or storage bin) is illustrated, generally designated by the reference numeral 320. Some containers of this form are also called “separators,” and are used to store and separate liquid products. Using conventional scintillating level detectors available in the past, the type of available ionizing radiation detectors have been solid, such as the detectors 330 and 350, that are placed along the sides of the container 320. This overall container and level measuring system is generally referred to by the reference numeral 300 on FIG. 11.

A source of ionizing radiation is placed at 310, along one of the vertical sides 326 of the container 320. Another side of the container is at 328, and this side is angled, as can be seen from the view. The bottom-most portion of the funnel container is at 324, while the top-most portion of the container is at 322.

The ionizing radiation source 310 is designed to emit radiation along the emission lines 312 and 314, and at angles therebetween. The emission line 312 represents the top-most level to be detected in this container system 300, while the emission line 314 represents the bottom-most level to be detected in container system 300. This configuration is arrived at merely by design choice in this example, and of course other angles for the top-most and bottom-most emission lines can be easily installed in such a system.

The upper level detector 330 is placed along the vertical side 326, and has a solid scintillating material at 342, which is in communication with a photomultiplier tube and electronic package, at 340. The detection region of this first detector 330 is between an upper-most level at 332, and a lower-most level at 334. A second solid scintillating level detector 350 is placed along the angled side 328 of the funnel container 320. The solid scintillating material runs along the sensor, and is illustrated at 362, which is in communication with a photomultiplier tube and electronic package at 360. The upper-most level to be detected is at 352 for this solid scintillating material 362, while the lower-most level to be detected is at 354. The upper-most level to be detected at 332 corresponds to the emission line 312, while the lower-most level to be detected at 354 corresponds to the emission line 314. Again, this can be easily changed, merely by using different sizes of detectors, or by using additional detectors, if a further (or lesser) elevation change needs to be detected.

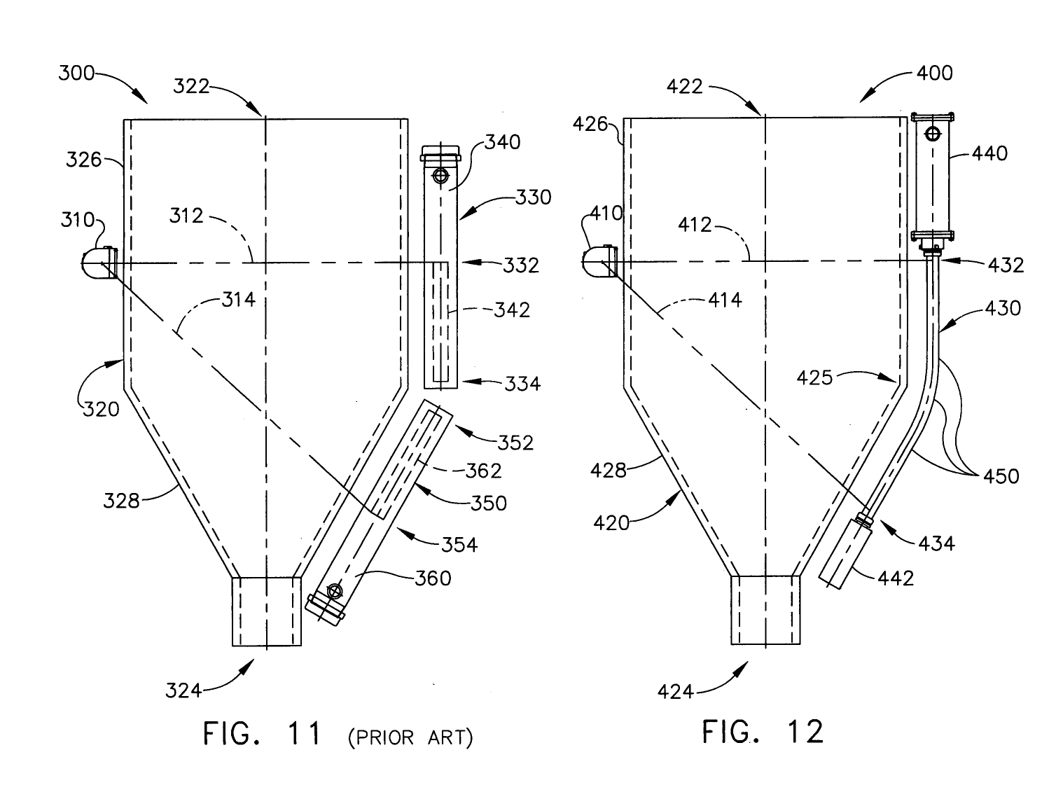

Referring now to FIG. 12, the same type of funnel-style container (or separator) is illustrated, this time designated by the reference numeral 420. However, a single flexible liquid-containing level detector, generally designated by the reference numeral 430, is now used, and this overall system is generally designated by the reference numeral 400. The vertical side of the container is at 426, while the slanted side is at 428. The bottom-most portion of the container is at 424, while the top-most portion of the container is at 422.

A source of ionizing radiation 410 is placed along the vertical side 426, and is designed to emit the ionizing radiation along the emission lines 412 and 414, as well as at all angles therebetween. A scintillating flexible tube level detector is placed along the vertical side and the slanted side, which is the detector 430. This is made possible by using the present invention. A photomultiplier tube with electronic package is located at 440 as the “sensing end,” while a “free end” is located at 442, which is a liquid-tight fitting.

Between the free end and the photomultiplier tube is a flexible tube that contains scintillating liquid material, and this tube is generally designated by the reference numeral 450. Since tube 450 is quite flexible, it can be run along the vertical side 426, the conical (or slanted side) 428, and past the corner between these two portions of the tank (i.e., the corner at the reference numeral 425). This is a configuration that was not possible before the present invention has become available, since solid scintillating detectors could not make the type of bend seen in this illustration, at least not without significant re-work, which could possibly damage the solid scintillating material.

The flexible tube scintillator at 450 is used to determine the product level within container 420, by detecting the gamma radiation being emitted by the source 410. The use of the word “level” in this paragraph represents the highest elevation of the product being detected within the container 420, and it is not directly referring to the amount of radiation received (which would be the magnitude or quantity of the radiation from the ionizing radiation source 410).

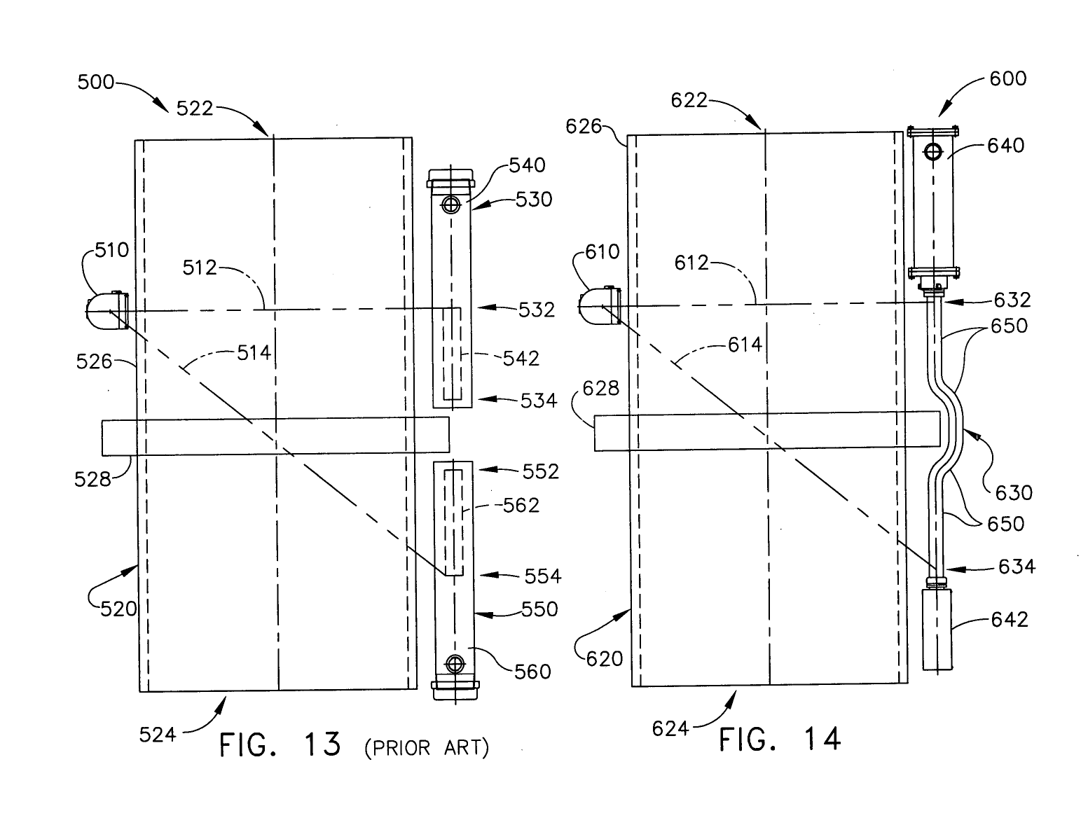

Referring now to FIG. 13, a container system generally designated by the reference numeral 500 is illustrated, which uses a vertical container 520 with a protruding structure at 528, which typically would be used as either a reinforcing ring, or as a flange to hold together two separate sections of material to make up a single material-holding container 520. Container 520 has a vertical wall 526, a top-most portion 522, and a bottom-most portion 524.

Container 520 could be cylindrical in profile, or it could have straight sides to make up a square or a rectangle, or perhaps some other polygonal shape, when viewed from above. In this example of FIG. 13, two separate conventional level detectors are used at 530 and 550. Each of these level detectors uses a solid scintillating material at 542 and 562, respectively.

An ionizing radiation source 510 is placed along the vertical wall 526 of the container 520. Radiation source 510 produces ionizing radiation along emission lines 512 and 514, and typically at all angles therebetween. The emission line 512 represents the upper-most level that can be detected in this system 500, while the emission line 514 represents the lower-most level that can be detected. Of course, this is only an example of such an installation, and using either different sizes of solid scintillating level detectors, or different numbers of such scintillating level detectors, the upper-most and lower-most levels (elevations) to be detected could be either expanded or reduced, as desired.

The upper level detector 530 is used for detecting the ionizing radiation from the emission line 512 down to the upper portion of the flange 528. The lower solid scintillating detector 550 is used to detect the levels of radiation between the lower portion of the flange 528 and the lower emission line 514. The use of the word “level” in the previous sentence represents the elevation of detection within the container 520, and is not directly referring to the amount of radiation received, which would be the magnitude or quantity of the radiation from the ionizing radiation source 510. As described above, if a solid or liquid product exists within the container 520, then the emission lines of ionizing radiation at lower elevations will be attenuated by that product, and will not reach the scintillating detector crystals at 542 and 562.

The upper detector 530 includes a photomultiplier tube with electronics package at 540, and the solid scintillating material 542. This can detect levels (or elevations) between the upper-most point 532 and the lower-most point 534. The lower solid scintillating detector 550 has a photomultiplier tube and electronic package at 560, and can detect levels (or elevations) between an upper-most point 552 and a lower-most point 554.

As can be seen by viewing this example of FIG. 13, a single solid scintillating detector could not be used to go around the flange 528, and instead, two separate scintillating detectors are employed. The type of small radius to go around such a bend in the tank outermost profile would be difficult, if not impossible, to achieve using solid level-detecting scintillators.

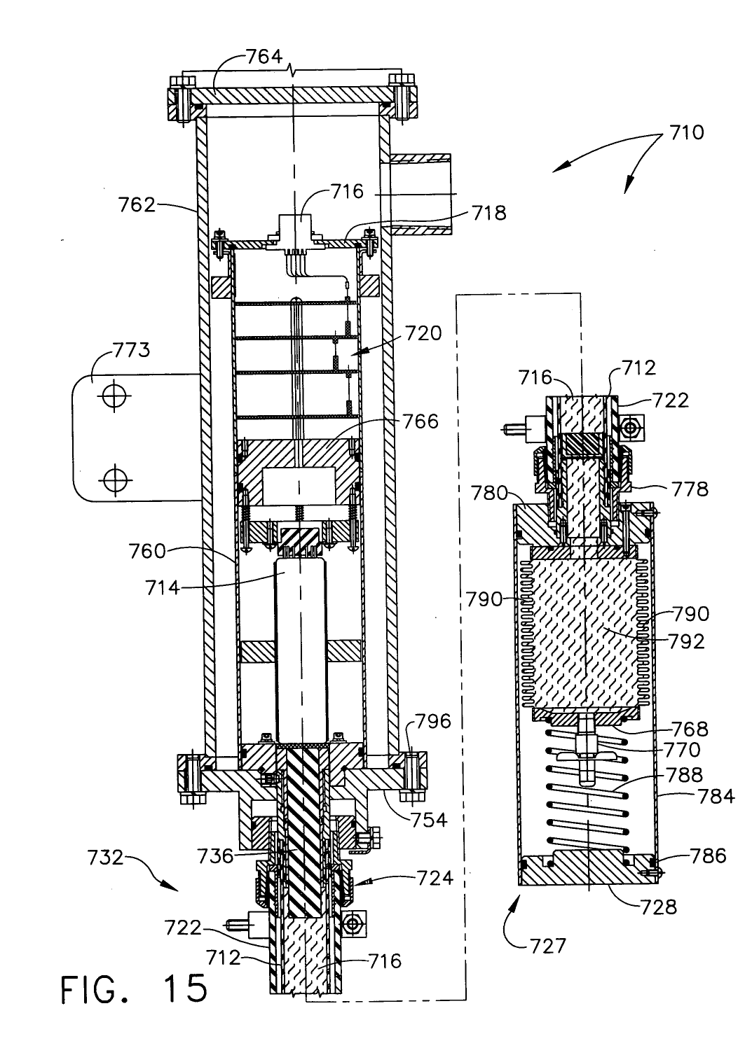

Referring now to FIG. 14, a similar tank is illustrated at 620, and has a protruding structure at 628 that acts as a reinforcing ring, or as a flange to connect two separate sections of the tank material itself. A single liquid-filled flexible scintillating level detector is used, generally designated by the reference numeral 630. This makes up a container and level detecting system, generally designated by the reference numeral 600.

Once again, tank 620 has an upper-most level at 622 and a lower-most level at 624, along with a vertical side 626. Tank 620 could have a cylindrical profile, or it could be made up of straight sides, as discussed above in reference to the tank 520 of FIG. 13.

A source of ionizing radiation 610 is placed along the vertical side 626 of the tank 620. This ionizing radiation source emits ionizing radiation along multiple angles, including along an emission line 612 and an emission line 614, and typically along all angles therebetween. The emission line 612 represents the upper-most level that can be detected in this system, while the emission line 614 represents the lower-most level that can be detected. As discussed above, this is by design in this example, and a wider or narrower angle could be detected, if desired by the system or installation designer.

A flexible tube-type scintillating level detector 630 is placed along the vertical side 626 of the tank 620, and this same, single detector 630 is also used to “bend” around the flange 628. This is made possible by using the present invention, in which a flexible tube 650 is employed between a top-most level detecting point 632 and a bottom-most level detecting point 634. The tube 650 is filled with a scintillating liquid material, for example, of a type discussed above. The tube 650 has a “free end” at 642, that is liquid tight. Tube 650 is in communication with a photomultiplier tube and electronic package at a “sensing end” 640.

The flexible tube scintillator at 650 is used to determine the product level within container 620, by detecting the gamma radiation being emitted by the source 610. The use of the word “level” in this paragraph represents the highest elevation of the product being detected within the container 620, and it is not directly referring to the amount of radiation received (which would be the magnitude or quantity of the radiation from the ionizing radiation source 610).

As in the example of FIG. 12, this level detecting system 600 has the capability of “lateral coupling” the electromagnetic radiation received along the flexible tube 650, and essentially coupling that radiation (at a different wavelength) in a lateral direction toward the photomultiplier tube at 640. This is a feature that was not possible until the present invention has become available. The use of a single set of multiplier tube with electronics will make this level detection system 600 much less expensive than the twin-detector situation used in the system 500 of FIG. 13. Moreover, there will be no need to attempt to “bend” a solid scintillating detector around an obstacle, such as the flange 528 on FIG. 13. In addition, it is quite easy to install the flexible tube level detector of the present invention, as will be discussed in more detail below.

Referring now to FIG. 15, a further alternative design of a liquid-filled scintillation detector is illustrated, generally designated by the reference numeral 710, having an improved volumetric expansion chamber that is positioned adjacent to or integral with the detector head portion of the device. In this device 710, the expansion chamber is located at a “free end” 727, which is on the opposite side or end of the detector apparatus 710 from a “detector end” 732. Between these free and detector ends 727 and 732 is the elongated liquid scintillator itself, which is inside a flexible tube 712 that is substantially surrounded by a sheath 722. The liquid scintillator material is designated by the reference numeral 716, and is contained within flexible tube 712.

At the very farthest end of the detector end 732 is an outer housing cover 764, which is bolted to an exterior housing 762. A mounting bracket 773 is attached to the exterior housing 762. Exterior housing 762 is connected to a head block 754, using bolts 796.

Within the exterior housing 762 is an interior housing 760, which contains the amplifier electronics at 720, and a photomultiplier tube 714. An electrical connector 716 is placed in a moisture-tight cover 718 above (in this view) the electronics amplifier 720. An internal ring 766 separates the amplifier 720 from the photomultiplier tube 714, and has a wiring passageway therein.

A transparent end plug 736 optically connects the photomultiplier tube 714 to the flexible tube 712 portion of the apparatus 710. A threaded coupling 724 holds the sheath portion 722 to the head block 754 and the photomultiplier tube 714.

At the “bottom” (in this view) of the free end 727 is an end cap 728. End cap 728 is mechanically connected to a housing 784, by use of seals or O-rings at 786. The end cap 728 also provides a spring post for a coil spring 788, which is part of the above-noted expansion chamber portion of the device, in which the expansion chamber portion is generally designated by the reference numeral 792.

At the “top” (in this view) of the expansion chamber 792 is a closure head 780, which is mechanically and fluidicly coupled to the sheath 722 and the flexible tube portion of the apparatus, by use of a coupler 778. The scintillator fluid 716 flows into the expansion chamber 792, and depending on temperature and pressure fluctuations, the expansion chamber can contract or expand, as needed. The liquid scintillating material in the expansion chamber 792 is surrounded by a bellows 790, and on the bottom (in this view) portion is a bellows bottom seal plate 768. The spring 788 also is emplaced against a portion or guide area of the seal plate 768 (which again acts as a spring post). A petcock 770 is available to drain fluid, if necessary.

As discussed above, various liquid materials have been tested and are usable as scintillation detectors in the present invention. These liquid materials should have an index of refraction that is greater than that of the tubing material, they should have a flash point greater than 93° C. (which would be above a combustible range for most explosion-proof applications), an attenuation length greater than three (3) meters, which would allow a detector to be longer than fifteen (15) feet (m), and a light output attribute greater than 50%. With regard to some of the materials discussed above, the physical parameters are presented in TABLE #1, as follows:

TABLE #1

| | BC599-16 | BC517H | BC517L | EJ-321H | EJ399-09 | EJ399-04 |
|---|---|---|---|---|---|---|
| Index of | 1.48 | 1.476 | 1.471 | 1.48 | 1.51 | 1.48 |
| Refraction | | | | | | |
| Light Output | 58% | 52% | 39% | 52% | 50% | 60% |
| Attenuation | 5 M | 5 M | 5 M | >5 M | >3 M | >3.5 M |
| Length | | | | | | |
| Flash Point (° C.) | 167.1 | 81.1 | 102 | 102 | 150 | 138 |
| COST | Moderate | Low | Low | Low | Moderate | Moderate |

Out of the above liquid scintillation materials, the BC599-16 material is probably the best one, based on its light output and attenuation length characteristics. It also has a very high flash point characteristic, which puts it well above the flammable and combustible mark for the explosion-proof process market. This liquid material also allows for an attenuation length of at least five (5) meters, which is a significant improvement over the solid crystal scintillators that have been used in level/elevation detectors in the past, and allows at least 23 feet (701 cm) of active area for the level/elevation detecting range.

With regard to the tubing material used for the flexible tube (e.g., tube 712 of FIG. 15), there are several properties of importance in level/relative elevation detecting applications. The index of refraction of the tubing material must be below that of the liquid scintillator material. The “bore” smoothness should be relatively high, since the smoother the material, the better for enabling light pulse reflections back into the liquid scintillator material. With regard to flexibility, it is preferred that the tubing material have a minimum bend radius of twelve (12) inches (30 cm) or less. For tubing size, the larger the better for most applications, because the larger cross-section results in more ionizing radiation being converted to more photons. For most level/elevation detector applications, the minimum tubing size is about one quarter inch (6 mm) while the maximum diameter would probably be about four (4) inches (101 mm). The tubing should be able to withstand and remain stable and flexible over process temperatures in the range of −50° C. to +80° C.

The CHEMFLUOR 367 liquid scintillator material meets all these requirements, as described below in TABLE #2:

TABLE #2

| | CHEMFLUOR 367 ™ |
|---|---|
| Index of Refraction | 1.34 |
| Bore Smoothness | 1.7 microns (peak to |
| | valley |
| Flexibility | 15″ radius standard |
| | (12″ with annular |
| | support) |
| Size | ¼″ to 1″ standard |
| Temperature | −400° F. to +450° F. |
| Cost | Moderate (¼″ to 1″) |
| | Prohibitive >1″ |

With regard to the outside protection for the inner tubing, the type of properties for the sheathing material include its size and its crushing protection characteristics. With regard to size, the sheathing material needs to be sufficiently large to fully encase and protect the interior tubing of the flexible tube. If CHEMFLUOR 367 is used, then the use of an annular supporting structure is preferred to assist in preventing kinking, and the proper size of the outer sheathing tubing is important to ensure that a bend radius of twelve (12) inches (30 cm) can be attained. The outer tubing should also help to prevent crushing of the interior tubing but still remain flexible. The design discussed above in reference to FIG. 9 will be sufficient for most applications. With regard to the environmental aspects of the material, the exposed outer material must hold up under typical weather conditions and be environmentally protective against chemical attack for most applications. Examples of appropriate sheathing materials are as follows, in TABLE #3:

TABLE #3

| | LiquiTite ™ | Xtraflex ™ | Liquid Tuff ™ |
|---|---|---|---|
| SIZE | ¼″ to 2″ | ⅜″, ½″, ¾″, 1″, | ⅜″, ½″,¾″, 1″, |
| | | 2″ | 1¼″, 1½″, 2″ |
| Protection | Internal metal coil | Stiff inner PVC | Solid PVC |
| Inside | 1.25″ | 2.0″ | 1.4″ |
| Diameter | | | |
| (for 1⅛″ | | | |
| O.D. for | | | |
| Chemfluor | | | |
| tubing) | | | |
| Material | PVC/Aluminum | PVC | PVC |

The design of the liquid-filled level/elevation detector of the present invention solves many of the problems discussed above. Since it is flexible, it can be coiled around a person's shoulder, neck, or arm, for example, and carried upstairs to a platform, and then mounted. It weighs less than the solid scintillator materials, and with a one inch-diameter interior tubing in the flexible detector (instead of a 2″×2″ solid PVT plastic detector in its schedule 40 pipe housing), the liquid scintillator material construction reduces the weight by about fourteen (14) pounds per foot (20.8 kg/m) of detector length. This is a significant advantage when the installer is carrying around a detector that has a twenty foot (610 cm) active length.

Since the present invention uses a flexible liquid-filled tube, this allows for installation in tanks or vessels in which the contour of the vessel is somewhat irregular, and where a solid (or rigid) detector could not readily be used. The liquid-filled detector is also much more linear in output from its top to its bottom, when measuring the level or elevation of an interior product within the vessel. These two factors often decrease the need for any extensive linearization procedures in the electronics or in software.

The temperature coefficient of the CHEMFLUOR 367 liquid scintillator material that may be used in the present invention is very good and will require no compensation between −50° C. to +70° C. (This is similar to the conventional solid PVT crystal material.) The liquid-filled detector of the present invention can also be installed in odd positions, including upside down, if desired. It would also be possible to use the liquid-filled detector in virtually any angular position desired, including at a diagonal, rather than strictly up and down (vertically) as in most installations.

The manufacturing cost of the flexible liquid-filled detector is also less, not only for the liquid scintillator material and its flexible tubing as compared to PVT-solid detectors, but also with regard to the various steps that must be performed during manufacturing. When using the PVT-solid material detectors, during manufacturing substantial manpower is required for cutting, polishing, and taping the PVT material in preparation for its use as a level/elevation detector. In the present invention, the flexible tubing needs to be cleaned, and then merely filled with the liquid scintillator material. This is a much easier and much less time consuming and labor intensive step, during manufacturing.

When installing the liquid-filled level detector of the present invention, the electronics can be calibrated by first energizing the ionizing radiation source, and then determining the “empty container” signal strength of the ionizing radiation at the flexible sensor itself. When the container (e.g., a tank or vessel) is empty of product contents, a maximum amount of ionizing radiation will be received at the level sensor, and this essentially is equivalent to “zero” level (or relative elevation) of the product contents. The container can then be filled to its maximum level, at least with respect to the desired detection range. At that maximum level or relative elevation, the signal strength of the ionizing radiation at the liquid-filled flexible sensor should be at a minimum value, and probably will be substantially zero, except for background gamma radiation. Once these two values are known, the level sensing detector is now available for use. If any linearization is needed, that can be done in the electronics of the level detector itself, or it can be done in software, if desired.

As used in this patent document, the term “relative elevation” of product contents within a container represents the position of the present level or elevation of a solid or liquid product in relation to the minimum level (or elevation) of interest for that container. It also can be thought of as the present position where an interface occurs, such as a liquid/liquid interface in a liquid separator, or a liquid/gas interface or a solid/gas interface in tanks or other product-holding containers. Once the inventive level detector has been calibrated, the relative elevation can be determined quite easily, usually by comparing the “zero scale” output signal value to the present output signal value.

It must be emphasized at this point that the word “level detector” in the present invention does not refer to the pure magnitude or quantity (or “level”) of radiation being received, but instead it refers to the actual level in terms of vertical height (or relative elevation) of the product contents (or their interface) within the container that is being measured. The present invention is not merely a neutron counter, or a radiation or radioactive particle magnitude detector that, without significant re-design, could not be realistically used to determine the relative elevation of a solid or liquid product (or an interface) within a container.

The overall weight of a liquid-filled flexible tube used as an exemplary level/elevation detector according to the present invention is about 1.5 pounds per foot (2.23 kg/m), which is more than a pound per foot lighter than the solid PVT-type crystal detectors that use PVC pipes as their outer housings. If a conventional installation uses schedule 40 iron pipe, the weight is much more, such as fifteen pounds per foot (22.3 kg/m). The present invention is only 1/10 of that weight, and therefore can be much more easily installed.

It will be understood that ionizing radiation typically includes both gamma ray and x-ray sources of electromagnetic radiation. Many level/elevation detectors can also be used with other types of “radiation” sources, such as alpha- and beta-type sources. Alpha particles are essentially helium nuclei, and beta particles are essentially high-speed electrons. When these particles strike many scintillator compounds, they also create the type of flash of electromagnetic energy that occurs in most scintillator materials. The liquid scintillator materials of the present invention will also react in some instances to alpha particles and beta particles, and from that standpoint, a “radiation source” in the vernacular of the present invention can also include alpha particle and beta particle sources. In general, a neutron source would not react well with the liquid scintillator material of the present invention, and thus it would not be able to detect such neutrons.

The embodiment shown is that which is presently preferred by the inventors. Many variations in the construction or implementation of this invention can be made without substantially departing from the scope of the invention. For this reason, the embodiments illustrated and described above are not to be considered limitive, but illustrative only.

As used herein, the term “proximal” can have a meaning of closely positioning one physical object with a second physical object, such that the two objects are perhaps adjacent to one another, although it is not necessarily required that there be no third object positioned therebetween. In the present invention, there may be instances in which a “male locating structure” is to be positioned “proximal” to a “female locating structure.” In general, this could mean that the two male and female structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two male and female structures actually touch one another along a continuous surface. Or, two structures of any size and shape (whether male, female, or otherwise in shape) may be located somewhat near one another, regardless if they physically abut one another or not; such a relationship could still be termed “proximal.” Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

All documents cited in the Detailed Description of the Invention are, in relevant part, incorporated herein by reference; the citation of any document is not to be construed as an admission that it is prior art with respect to the present invention.

The foregoing description of a preferred embodiment of the invention has been presented for purposes of illustration and description. It is not intended to be exhaustive or to limit the invention to the precise form disclosed. Any examples described or illustrated herein are intended as non-limiting examples, and many modifications or variations of the examples, or of the preferred embodiment(s), are possible in light of the above teachings, without departing from the spirit and scope of the present invention. The embodiment(s) was chosen and described in order to illustrate the principles of the invention and its practical application to thereby enable one of ordinary skill in the art to utilize the invention in various embodiments and with various modifications as are suited to particular uses contemplated. It is intended to cover in the appended claims all such changes and modifications that are within the scope of this invention.

The invention claimed is:

1. A product level detector system, comprising:
a container that holds a mass, said container having a first surface portion and a second surface position;
an elongated flexible tubular member that is physically located at said first surface portion of the container, said tubular member having a first closed end and a second closed end, said tubular member having an interior region that is substantially filled with a liquid scintillation material which is sensitive to detecting ionizing radiation;
a photosensitive device located near said first closed end of the tubular member, said photosensitive device detecting scintillating photons generated in the scintillation liquid that are indicative of ionizing radiation passing into the liquid scintillation material, said photosensitive device generating an output signal that is related to a quantity of said scintillating photons;
an ionizing radiation source that is physically located at said second surface position of the container; and
an electrical detection circuit that determines a relative elevation of said mass being held by said container, based upon a value of said output signal of the photosensitive device.

2. The product level detector system as recited in claim 1, wherein said tubular member is sufficiently flexible to be placed substantially along said first surface portion of the container, substantially regardless of the physical shape of the first surface portion.

3. The product level detector system as recited in claim 2, wherein said tubular member is placed along said first surface portion of the container substantially from a bottom-most location of said container to a top-most location of said container.

4. The product level detector system as recited in claim 2, wherein said tubular member is placed along said first surface portion of the container for a distance that is related to measuring a desired range of relative elevations of said mass being held by said container.

5. The product level detector system as recited in claim 1, wherein said liquid scintillation material is sensitive to detecting gamma radiation, and is not substantially sensitive to detecting radioactive particles.

6. The product level detector system as recited in claim 1, wherein said tubular member comprises:
an inner flexible tubular material of substantially cylindrical shape, having a first outer diameter dimension and a first inner diameter dimension;
said inner flexible tubular material is at least partially covered by at least one layer of an insulative material that is substantially flexible, said at least one layer of insulative material having an outermost physical dimension that is greater than said first outer diameter dimension of the inner flexible tubular material; and
said at least one layer of an insulative material is substantially surrounded by an outer flexible tubular material of substantially cylindrical shape, having a second outer diameter dimension and a second inner diameter dimension, said second inner diameter dimension being greater in physical size than said outermost physical dimension of the at least one layer of insulative material by a sufficient distance so as to provide a gap therebetween, to provide greater flexibility and a smaller bending radius for said tubular member.

7. A product level detector, comprising:
an elongated flexible tubular member that has a first closed end and a second closed end, said tubular member having an interior region that is substantially filled with a liquid scintillation material which is sensitive to detecting ionizing radiation;
said liquid scintillation material reacting to ionizing radiation passing into the liquid scintillation material by generating scintillating photons, said ionizing radiation being of a first wavelength and said scintillating photons being of a second, different wavelength, said ionizing radiation arriving at first angles that are not parallel to a longitudinal axis of said tubular member, and said scintillating photons being directed along said interior region of the tubular member at different second angles, thereby effectively providing lateral coupling between said ionizing radiation and said scintillating photons; and
a photosensitive device located near said first closed end of the tubular member, said photosensitive device detecting said scintillating photons and generating an output signal that is related to a quantity of said scintillating photons.

8. The product level detector as recited in claim 7, further comprising an electrical detection circuit that determines a relative elevation of a mass being held by a container that is proximal to said product level detector, based upon a value of said output signal and based upon a predetermined value of said output signal when said external container is empty.

9. The product level detector as recited in claim 8, wherein said electrical detection circuit is configured to:
(a) determine an “empty container” strength of the ionizing radiation by detecting a maximum value of said output signal during system setup, when said external container is empty;
(b) determine a “full container” strength of the ionizing radiation by detecting a minimum value of said output signal during system setup, when said external container has a product contained therewithin, at least up to a maximum elevation of interest;
(c) then determine a “real time” strength of the ionizing radiation by detecting a present value of said output signal, during normal operation of the product level detector, and when said external container is not empty; and
(d) then determine a present relative elevation of a product contained within said external container by relating said present value of the output signal to said maximum value of the output signal, substantially in real time.

10. The product level detector as recited in claim 7, wherein said ionizing radiation comprises one of: (a) gamma rays; and (b) X-rays.

11. A product level detector, comprising:
an elongated flexible tubular member that has a first closed end and a second closed end, said tubular member having an interior region that is substantially filled with a liquid scintillation material which is sensitive to detecting ionizing radiation; and
a photosensitive device located near said first closed end of the tubular member, said photosensitive device detecting scintillating photons generated in the scintillation liquid that are indicative of ionizing radiation passing into the liquid scintillation material, said photosensitive device generating an output signal that is related to a quantity of said scintillating photons;
wherein:
(a) said liquid scintillation material has an index of refraction greater than or equal to (≧) 1.4, a thermal flash point temperature greater than (>) 93° C., a light output characteristic greater than or equal to (≧) 50%, and an attenuation length greater than (>) 3 meters; and
(b) said elongated flexible tubular member has an index of refraction less than (<) 1.4.

12. The product level detector as recited in claim 11, wherein an inner diameter dimension of said flexible tubular material is in a range of about 0.25 inches (6 mm) to about 4.0 inches (102 mm).

13. The product level detector as recited in claim 11, wherein said flexible tubular material has a bore smoothness of about 1.7 microns, peak to valley.

14. The product level detector as recited in claim 11, wherein said flexible tubular material has an operating temperature characteristic in a range of about −400° F. to +450° F. (−240° C. to +232° C.).

15. The product level detector as recited in claim 11, wherein said liquid scintillation material has an index of refraction greater than (>) about 1.4, a thermal flash point temperature of about 150-167° C., a light output characteristic of about 58%, and an attenuation length of about 5 meters.

16. The product level detector as recited in claim 11, wherein said ionizing radiation comprises one of: (a) gamma rays; (b) X-rays; (c) alpha particles; and (d) beta particles.

17. The product level detector as recited in claim 11, further comprising a variable volume expansion chamber that is in fluidic communication with said liquid scintillation material in said interior region of the tubular member, said expansion chamber having a bellows capable of expanding and contracting, said expansion chamber being spring-loaded, and said expansion chamber being located proximal to said second closed end of the tubular member.

18. A method of installing a product level detector, said method comprising:
(a) providing a product level detector apparatus with an elongated flexible tubular member having a first closed end and a second closed end, and an interior region that is substantially filled with a liquid scintillation material which is sensitive to detecting ionizing radiation; and a photosensitive device located near said first closed end of the tubular member, said photosensitive device detecting scintillating photons generated in the scintillation liquid that are indicative of ionizing radiation passing into the liquid scintillation material, said photosensitive device generating an output signal that is related to a quantity of said scintillating photons;
(b) providing a container that holds a mass;
(c) coiling said tubular member in a convenient carrying position for a person who will perform an installation of said product level detector apparatus;
(d) climbing, with said tubular member wrapped around the person's body, to a location at which said product level detector apparatus is to be installed; and
(e) mounting said product level detector apparatus to a surface of said container, after which said product level detector apparatus will be positioned to detect a relative elevation of a product within said container, within a desired range of product elevation detection.

19. The method as recited in claim 18, wherein said elongated flexible tubular member has a unit weight of about 1.5 pounds per foot (2.23 kg per m), or less.

20. The method as recited in claim 18, wherein said tubular member is wrapped around one of: (a) said person's arm; (b) said person's shoulder; and (c) said person's neck.
